(19) United States
(12) Patent Application Publication
(10) Pub. No.: US 2007/0243301 A1
(43) Pub. Date: Oct. 18, 2007

(54) Process for Producing Rice-Based Expandable Pellets and Cracker-Like Snacks

(76) Inventors: Michelle Latrese Barnett, Plano, TX (US); Ajay Rajeshwar Bhaskar, Allen, TX (US); Robin Scott Hargrove, Flower Mound, TX (US); Jason Thomas Niermann, Frisco, TX (US); V.N. Mohan Rao, Plano, TX (US); Craig Jordan Weitz, Dallas, TX (US)

Correspondence Address: CARSTENS & CAHOON, LLP, P O BOX 802334, DALLAS, TX, 75380, US

(21) Appl. No.: 11/279,795

(22) Filed: Apr. 14, 2006

(51) Int. Cl. A21D 13/00

(52) U.S. Cl. 426/559

(57) ABSTRACT

With the process for producing rice-based expandable pellets, an intermediary product is manufactured that is capable of being stored for up to about six months. These pellets can be later expanded into a food product, particularly a rice based snack product that has improved flavor qualities and decreased oil pick up. To form the pellets, a rice meal is passed through a low shear extruder. The extrudate produced is then cut into pellets.

### BACKGROUND OF THE INVENTION

1. Technical Field

The present invention relates to a process for producing expandable rice-based pellet snacks and, in particular, to a process for producing expandable rice cracker-like pellets using a twin screw extruder with and without a former. The process produces shelf stable products that can be later processed into finished snack products.

2. Description of Related Art

The process for producing pellets as generally adapted in the food industry involves the cooking of starch and forming a shape, such as a particular pasta shape, wherein the product is later cooked in the presence of excess water. The cooked mass is sheeted, cut, and dried for later frying.

Typical pellet or half-products require two steps to produce a finished snack product. In a first step, the ingredients, which generally include cereal products and starches, are hydrated to form an extrudable mixture. During extrusion, the ingredients are partially gelatinized creating dough, which is passed through a die. The dense sheeted material, which contains from about 20% to about 40% moisture by weight, is then cut into pellets (with or without lamination) and processed through a dryer to arrive at a final moisture of about 10% to about 14%. This product can then be stored and later processed in a second cooking step.

One advantage of a half-product is that it is inexpensive and easy to handle. Because half-products or pellets can be stored for relatively long periods of time before further processing, they can be centrally manufactured and shipped to several facilities in different geographical regions for a final cooking step. Further, following cooking, seasonings can be added that accommodate diverse geographical preferences.

Prior art pellet making processes have focused upon corn-based products, as illustrated by U.S. Pat Nos. 6,224,933 and 6,242,034 and potato-based products, as illustrated by U.S. Pat. No. 6,432,463. While potato-based snack products and corn-based snack products are known, it would be desirable to have food products made with alternative compositions to make products that have different nutritional and flavor profiles. For example, many consumers are increasingly health-conscious and desire healthier, natural-flavored snack food products with higher levels of fiber and lower levels of fat than many traditional corn or potato-based snack foods. After frying, corn-based products can have an oil content of more than 25% by weight and the potato-based products can have an oil content of more than 35% by weight. Further, corn-based products have a very distinctive flavor, which can result in a limited set of flavor profiles.

Rice is considered by consumers to be a healthy food product. Many rice-based food products such as rice-based crackers are popular in many Asian markets. Unfortunately, the process for making rice-based crackers is long and laborious. As disclosed by U.S. Pat. No. 3,925,567, the process can easily take more than a day.

Accordingly, a need exists for a process for making expandable rice-based pellets and cracker like snacks which have pellet attributes including significant storability, improved shape, texture, and flavor while being easily manufactured. Further, the expandable pellet should, in one embodiment, provide the consumer with a reduced fat, and/or higher fiber snack food while providing natural flavor profiles.

### SUMMARY OF THE INVENTION

The invention comprises a process for continuously producing rice based expandable pellets and cracker like snacks. The rice base comprises rice flours, which can include white rice, medium or long grain whole grain rice, or pre-cooked rice flour. In one embodiment, one or more secondary ingredients selected from vegetable powders, fruit powders, pre-gelatinized starches, native starches, and/or non-rice flour(s) can be optionally added to the rice flour admix. Additionally, minor ingredients such as sugar, salt, oil and/or an emulsifier can be added to the rice flour thereby forming a rice flour admix. The rice flour admix is then passed through a preconditioner for mixing, hydration, and partial thermal cooking to become a dough.

After being hydrated, the rice dough is routed through a low shear extruder. The extruder first mechanically shears and cooks and then cools the meal before passing it through a die to form a thin wide ribbon. The ribbons are then cooled and cut into pellets.

Once the pellets are formed, they are transferred to a series of dryers. The first dryer is a shaker/rotary dryer that drives off the outer moisture and prevents formation of clusters during the initial drying phase. This is followed by passing the pellets through a pre-dryer where pellet moisture is reduced without hardening the surface. To equilibrate the pellet moisture and minimize any moisture gradient, a finishing dryer further dries the pellets. The dried pellets are then ready for packaging for later cooking by, for example, frying, air puffing, or baking/toasting.

In one aspect, the invention provides a method for making a reduced-fat, fried, rice-based snack food. A rice-based pellet is pre-heated to dehydrate and melt at least a portion of the starch in the outer pellet surface. The pellet is then subsequently fried and thereby expanded in hot oil. The resultant expanded snack comprises an oil content of less than about 22% by weight. The expanded pellet can then be seasoned and packaged. In this embodiment, the seasoned, packaged rice-based snack comprises less than about 6 grams of fat in a 28 gram serving.

In one aspect, the pellets are cooked and thereby expanded in a hot air popper or an oven. The expanded snack can then be seasoned and packaged. In this embodiment, the seasoned, packaged rice-based snack comprises less than about 5 grams of fat in a 28 gram serving.

The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flow chart showing the process for making a rice-based expandable pellet and expanded rice snack; and

FIG. 2 is an end view representation of the extruder die in accordance with one embodiment of the present invention.

### DETAILED DESCRIPTION

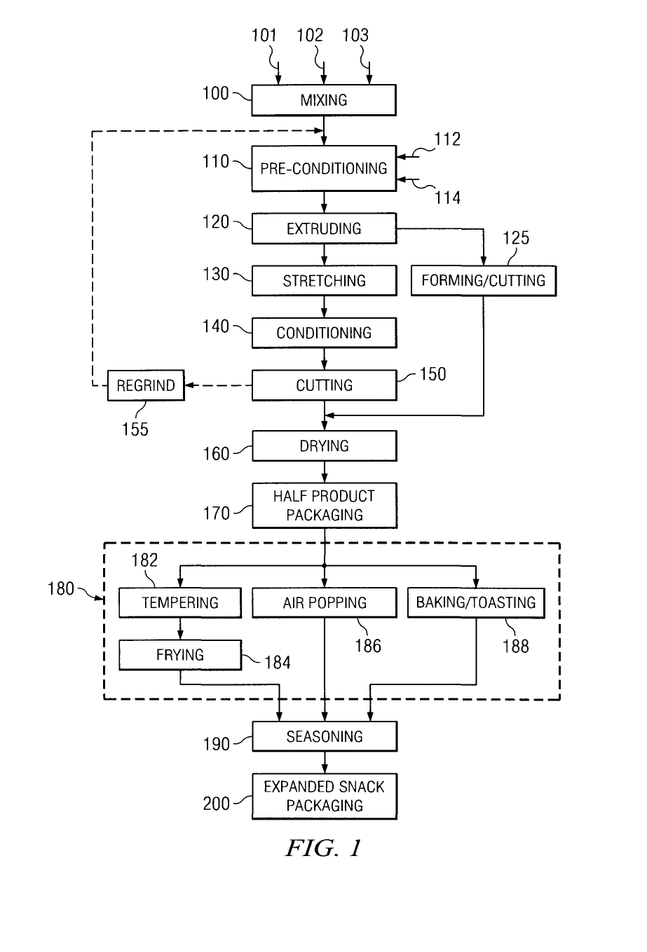

The present invention is an expanded rice-based pellet process that generates half-products (pellets) that are shelf stable and can be finished or otherwise rethermalized at a later time (up to 6 months). FIG. 1 shows a schematic block diagram illustrating various processes for making expanded pellets from a rice base in accordance with various embodiments of the present invention. In one embodiment, one or more primary ingredients comprising a rice flour composition 101 is mixed with one or more minor ingredients 103 selected from sugar, oil, emulsifier, and salt in a dry mixer 100 to make a rice flour admix.

The rice flour composition 101 can comprise one or more types of rice flour. For example, the rice flour composition 101 can comprise one or more rice flour types selected from short grain rice flour, long grain rice flour, and medium grain rice flour. The rice flour composition 101 can be selected from one or more rice flour varieties selected from white rice, whole grain rice, brown rice, basmati rice, Wehani rice, jasmine rice, Arborio rice, wild rice, and converted rice. Whole grain rice flour can be desirable as it has more fiber and vitamins than other types of flours. Whole grain brown rice comprises about 4.6% fiber by weight and whole grain wild rice comprises about 5.6% fiber by weight. Furthermore, the composition can comprise rice flour that is partially or fully gelatinized, or combinations thereof. For example, the rice flour can be selected from gelatinized rice flour, partially gelatinized rice flour, partially pre-cooked rice flour, pre-cooked rice flour, par-boiled rice flour, uncooked rice flour, and extruded rice flour.

In one embodiment, secondary ingredients 102 comprising one or more vegetable powders can be added to the rice flour admix to adjust the flavor and/or nutritional profile. In one embodiment, one or more vegetable powders selected from tomato, spinach, and asparagus can be used. Other vegetable powders selected from carrot, broccoli, cucumber, kale, parsley, cabbage, celery, cauliflower, green bell pepper, green beans, Brussels sprouts, onion, garlic, and/or ginger can also be used. Such vegetable powders are available from Quest of Silverton, Oreg. Vegetable powders can be added in sufficient amounts to achieve the desired nutritional profile. For example, vegetable powders can be added to increase the fiber in the food product. Tomato powder, for example, comprises 16% fiber by weight. Further, in one embodiment, addition of a sufficient amount of vegetable powder can result in an expanded snack product having the equivalent of at least one-third serving of vegetables.

The United States Department of Agriculture defines a serving of vegetables as ½ cup of chopped vegetables. A serving of vegetables comprises a moisture content and a solids content. Stated differently, a serving of vegetables comprises a solids content on a dry basis. The USDA National Nutrient Database for Standard Reference defines the weight of the edible portion of a vegetable in that ½ cup and defines the average moisture and thus solids content of the edible portion of a vegetable. Table 1, for example, depicts the nutrient profile for 1-cup or 180 grams of a red, ripe, raw, year round average tomato as accessed at http://www.nal.usda.gov/fnic/foodcomp/search/.

TABLE 1
Tomatoes, red, ripe, raw, year round average

| | | | | | 1.00 |
|---|---|---|---|---|---|
| | | Value | | | cup, |
| | | per | Number | | chopped |
| Nutrient | | 100 | of Data | Std. | or sliced |
| Proximates | Units | grams | Points | Error | 180 g |
| Water | g | 94.50 | 33 | 0.159 | 170.10 |
| Energy | kcal | 18 | 0 | 0 | 32 |
| Energy | kj | 75 | 0 | 0 | 135 |
| Protein | g | 0.88 | 19 | 0.039 | 1.58 |
| Total lipid (fat) | g | 0.20 | 26 | 0.034 | 0.36 |
| Ash | g | 0.50 | 19 | 0.018 | 0.90 |
| Carbohydrate, by difference | g | 3.92 | 0 | 0 | 7.06 |
| Fiber, total dietary | g | 1.2 | 5 | 0.234 | 2.2 |
| Sugars, total | g | 2.63 | 0 | 0 | 4.73 |
| Sucrose | g | 0.00 | 12 | 0.002 | 0.00 |
| Glucose (dextrose) | g | 1.25 | 16 | 0.135 | 2.25 |
| Fructose | g | 1.37 | 17 | 0.073 | 2.47 |
| Lactose | g | 0.00 | 9 | 0 | 0.00 |
| Maltose | g | 0.00 | 9 | 0 | 0.00 |
| Galactose | g | 0.00 | 4 | 0 | 0.00 |
| Starch | g | 0.00 | 4 | 0 | 0.00 |

USDA National Nutrient Database for Standard Reference, Release 18 (2005)

As used herein, a vegetable serving is defined as the solids content that is equivalent to ½ cup (118 cubic centimeters) of a chopped fruit or vegetable on a dry basis. According to Table 1, one cup of red, ripe, raw, year round average tomatoes weighs 180 grams, and has a water content of 94.5% by weight. Consequently, ½-cup or a vegetable serving of tomatoes having a total weight of 90 grams has a non-water or solids content of 5.5% by weight. Consequently, 4.95 grams (5.5% solids content×90 grams total weight) of tomato solids in a finished product is equivalent to a vegetable serving. (As known to those skilled in the art, vegetable powders typically have a moisture component, e.g., tomato powder is 5% moisture by weight. Consequently, the amount of vegetable powder may not directly correspond to the amount of tomato solids.) Thus, an expanded snack having a one-third vegetable serving would have approximately 1.65 grams of tomato solids in a 28 gram serving and an expanded snack having a one-half vegetable serving would have approximately 2.48 grams of tomato solids in a 28 gram serving. Consequently, in one embodiment, vegetable powder can be added in an amount sufficient to provide for a one-third vegetable serving and in a preferred embodiment in an amount sufficient to provide for a one-half vegetable serving.

One advantage of using rice as a primary ingredient is that because rice has a neutral flavor, flavors added to the rice e.g., “natural” flavors from vegetables powders, can be easily imparted to the resultant rice-based product and can therefore positively impact the flavor profile. Consequently, the addition and combination of vegetable powders can be adjusted to achieve the desired natural flavor profile. Use of vegetable powders further permits a consumer to enjoy a natural-flavored snack food product having a natural flavor.

Secondary ingredients 102 such as pre-gelatinized potato starch can also be added to aid in dough machineabilty through the extruder and help maintain the elasticity of the extrudate exiting the extruder. The extrusion of relatively low pH vegetable powders can negatively impact the texture and appearance of the finished rice-based product. However, the applicants have found that these problems can be overcome by using more pregelatinized starches and lowering the shear used in the extruder. Secondary ingredients 102 can comprise one or more starch ingredients selected from native starch, pre-cooked starch, and/or modified starches depending on the formulation and source of vegetable powder. The starch ingredients can be from corn, potato, or tapioca.

The rice flour admix is then fed to a preconditioner 110 for mixing and hydration 112 with water and/or steam. Further, the preconditioner 110 also partially gelatinizes the mixture prior to extrusion. Oil 114 is optionally added to the preconditioner 110 for controlling expansion and for product release at cutting 150.

During extrusion, the mixture is mechanically sheared and cooked in an extruder 120 at low shear. As used herein, a low shear is defined as a Specific Mechanical Energy (SME) range of about 80 to about 140 w-h/kg per dry mix basis. The mixture is then cooled in the downstream extruder zones, e.g. zones 5-7 in a 7-zone extruder, prior to being passed through a die. Upon passing through the die, in one embodiment, the extrudate comprises a thin wide ribbon that is routed to an endless open mesh moving belt for stretching 130 and is then routed to a ribbon conditioner 140. When the ribbon is cut 150 into shaped pellets, the residue material or lace from the ribbon can be recycled 155 to a regrinder for refeeding to the preconditioner.

In an alternative embodiment, the extrudate exits the extruder 120 as dough balls having a diameter of between about 10 mm and about 20 mm. In one embodiment, these dough balls are routed to a low shear single screw former 125. The dough balls comprise a moisture content of greater than about 20% and more preferably greater than about 25% to aid machineability in the former 125. The former 125 can have a die face plate with the same or multiple shapes and a rotary cutter to cut the extrudate into a pellet at the die faceplate. In one embodiment, the barrel temperature in the former is to be maintained below about 70° C. Temperatures above this range can have undesirable effects on some powders such as tomato powder.

The pellets from either cutting step 125 150 can then be sent to one or more ovens for dehydration in a drying step 160. In one embodiment, the drying or dehydration step 160 comprises a shaker or rotary dryer, short or pre-dryer, and finishing dryer for drying the pellets to a moisture level for packaging. After drying, the rice-based pellets are cooled atmospherically on a slow moving conveyor belt to ambient and can then be packaged 170 for later processing or can be routed for immediate cooking into an expanded snack product.

Pellets manufactured in accordance with the above-described features are capable of being stored for up to about six months. Upon being cooked, these pellets expand into a rice based snack product that has a unique flavor and nutritional profile.

To form a snack product, the pellets can be expanded through a cooking step 180. The cooking step can comprise frying 184, pre-heating 182 followed by frying 184, air popping 186, or baking/toasting 188.

It has been surprisingly discovered that, in a frying embodiment, the amount of oil pick-up can be lowered to produce a reduced-fat pellet if the rice-based pellets are first tempered 182 prior to a frying step 184. As used herein, “reduced fat” means that the fat content is less than about 18% by weight of the expanded snack after the seasoning step. For example, in one embodiment, a plurality of rice pellets made from a process similar to that discussed above can be tempered 182 at temperatures of between about 71° C. (160° F.) and about 110° C. (230° F.) and more preferably between about 82° C. (180° F.) and about 104° C. (220° F.). In one embodiment, the rice pellets are tempered for a residence time of more than about 3 minutes. In one embodiment, the rice pellets are tempered 182 for a residence time of less than about 6 minutes. Without being bound to theory, it is believed that the tempering 182 or heating step partially gelatinizes the outer pellet surface. This can cause the starch on the outer pellet surface to melt, which results in a shiny looking surface. The melting of the outer pellet surface may act to “seal” any pores on the outer portion of the pellet. Further, the heat will also further dry the outer portion of the pellet and can create a moisture gradient. When the pellet is subsequently placed into the fryer 184, the tempered pellet, having a partially or fully sealed and partially or fully dried outer pellet surface, can inhibit oil penetration, resulting in less oil pick-up when in the fryer. Further, because tempering 182 most affects the moisture on the outer pellet surface, the overall moisture content of the pellet will decrease only slightly. Consequently, the pellet after tempering can comprise a moisture content of between about 8% and about 13% and more preferably between about 10% to about 12%. When placed in hot oil and fried 184, the moisture inside the pellet will vaporize causing the pellet to expand, but the outer surface will inhibit oil penetration. Consequently, the tempering step 182 surprisingly helps to produce a reduced fat expanded pellet or expanded snack. It is believed that such process can also be expanded to other expanded pellets including, but not limited to corn-based pellets and potato-based pellets.

Pellets are submerged the entire time they are fried ensuring uniform frying of both pellet surfaces. To expand the pellets to a desired degree, the fryer temperature is manipulated. Bulk density is measured on-line after the fryer prior to seasoning. The fried base is oil sprayed and seasoned in a rotating drum typical of corn chip processing. The expanded and seasoned product is then packaged by, for example, a vertical form and fill machine.

A reduced fat expanded pellet or snack can be made by baking or air popping the snack until product achieves bulk density between about 60 g/l and about 80 g/l.

The following are prophetic and actual examples of several embodiments of the present invention:

### EXAMPLE 1

### Baked Reduced Fat Rice Cracker Like Pellet Product

Rice Pellet Preparation

An exemplary process as shown in FIG. 1 starts with weighing step wherein the respective ingredients are mixed. In operation, the rice flour ingredients 101 are first weighed, which include white rice, medium grain rice flour, and pre-cooked rice flour at about 50% and 99% and more preferably between about 80% to about 95%, secondary ingredients 102 comprising pregelatinized starch at about 0% to about 30%, and more preferably between about 3% and about 12%, and minor ingredients 103 comprising sugar at about 0% to about 3% and more preferably between about 1% and 2.5%, less than about 0.5% of an emulsifier and oil at about 1% to about 3%, and more preferably about 1.5%, and salt at about 1.5%. In one embodiment, the medium grain rice flour to pre-cooked rice flour comprises a ratio of between about 1.50:1.00 to 1.25: 1.00. Such ratio can result in a superior texture and appearance of the finished baked rice product. Although salt and sugar are primarily added for flavor, these ingredients can also have desirable secondary effects on the final product texture. The emulsifier reduces stickiness in the pre-conditioner and is a processing aid in the extruder.

The rice flour mixture is then mixed 100 to assure sufficient blending of the ingredients, which for example can occur after about 15 minutes to make a rice flour admix. The rice flour admix is volumetrically fed to a preconditioner 110 which is a single shafted paddle mixer for example. In the preconditioner, moisture 112 is added to the dry mixture in the form of liquid water and steam to hydrate and partially gelatinize the mixture. In this embodiment, the rice flour admix enters the preconditioner 110 at a wet basis moisture of about 12% and exits as a rice meal (hydrated flour mixture) having a moisture content of about 30% to about 40% by weight. As used herein, the terms “dough” and “meal” are synonymous and refer to a hydrated rice flour admix. In a preferred embodiment, the meal's mean residence time in the preconditioner 110 is about 1 to about 4 minutes. The total combined weight of the water and steam is maintained in order to achieve a consistent moisture level of the meal as it exits the preconditioner 110. The water that is added is preheated typically to about 65° C. to about 71° C. to maintain an exit temperature of the mixture at about 60° C. to about 90° C., more preferably about 77° C. which is adequate to inhibit microbial growth within the preconditioner 110 and sufficiently encourages the diffusion of steam and water into the meal. The amount of steam can be adjusted to control the exit temperature of the meal from the preconditioner 110. A hot water jacket around the preconditioner 110 can additionally be used to moderate and control the temperature level of the mixture. Oil, including, but not limited to corn oil, cottonseed oil, and/or sunflower oil, is added to the preconditioner 110 to aid with handling of the product after extrusion.

After pre-conditioning 110, the meal undergoes an extruding step 120 in a twin screw extruder. The extruder, in one embodiment, is a Mapimpianti twin screw model tt92/28D having a L/D ratio of 28, a shaft for of 89 mm, and consists of seven barrel zones. The meal and additional water are fed into the first zone. For example, the extruder can be set to a screw RPM of 250 and preferably between 220 RPM to 280 RPM to optimize the mechanical input to the meal. Barrel zones two through four are heated to a barrel temperature sufficient to achieve the desired level of cook by mechanical and thermal processes which is generally between about 48° C. to about 108° C. Barrel zones five through seven are cooled to less than about 70° C. to minimize extrudate die temperature and to help reduce steam flashing at the die. Otherwise, steam flashing produces undesirable bubbles in the resulting extrudate ribbon as the temperature of the extrudate reaches about 108° C. to about 113° C. and is exposed to atmospheric pressure. The extruder has a lateral and central head temperature of about 90° C. and a die pressure of about 40 bar to about 90 bar. Further, a vacuum vent is attached to zone four to remove excess steam and provide evaporative cooling of the extrudate. A typical vacuum level is achieved at about 50 mm of mercury with an evaporative rate of about 15 kilograms to 30 kilograms of water per hour.

Another quality control feature of the invention is the variation of water added to the extruder. Since the flour mixture has been hydrated in the preconditioner 110 and excess water can be removed by vacuum, the addition of water acts as a lubricant to the flour mixture, reducing its viscosity and, thereby, reducing the residence time of the flour mixture in the extruder. This reduces the torque required to transfer the less viscous product through the extruder. Consequently, the addition of water to the extruder reduces the cook level.

To obtain a maximum residence time and minimal shear that is required for optimum product flavor and texture, the RPM of the extruder is reduced. As the rotation speed decreases, the residence time of the rice meal increases. The lower the extruder RPM is the more bed packing and longer residence time in the extruder, and uniformity in time of the flow out of the die occurs. It is believed that the degree of cook of the extrudate is slightly higher at a lower RPM than at a higher RPM. In one embodiment, a typical operating range for the extruder is between about 220 RPM to about 280 RPM with an extrudate temperature of about 95° C. to about 107° C. In one embodiment, the rice meal comprises an extruder residence time of more than about 30 seconds. In one embodiment, the rice meal comprises an extruder residence time of less than about 90 seconds. In one embodiment, the rice meal comprises a residence time of between about 50 seconds and about 80 seconds.

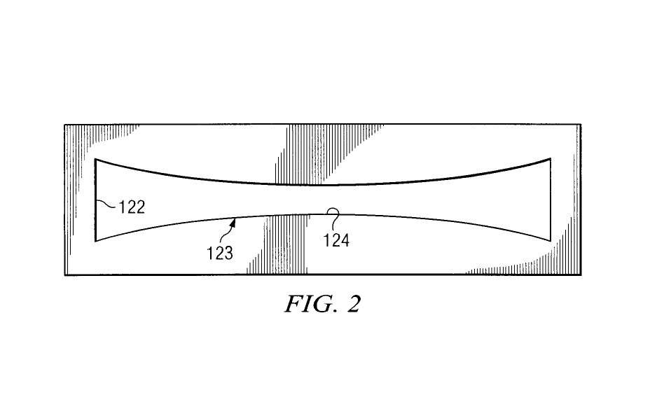

The minimally sheared extrudate is then fed through a single die with adjustable choker bars and die lips. Non-uniformity of the extrudate thickness across the width of the extrudate ribbon is minimized with fine-tuning of the orifice between the die lips. For example, referring to FIG. 2, which depicts an end view of an orifice die 122, a twin-screw extruder can apply more force towards the middle 124 orifice portion. Consequently, in one embodiment, the orifice comprises a variable diameter lip in the shape of an hour-glass 123.

The ribbon at the die face is very pliable, but quickly stiffens into a sheet that can be mechanically manipulated without significant deformation to the ribbon and yet remain somewhat flexible. Referring back to FIG. 1, after the ribbon exits the extruder 120, the ribbon is thereafter transferred onto an endless open mesh moving belt. In one embodiment, the open mesh belt is run at a speed slightly higher than that of the extruded ribbon to stretch, without breaking, the ribbon in the direction of travel and reduce the ribbon thickness. Ribbon stretching 130 in this way provides numerous advantages and benefits. First, the amount of mechanical energy imparted on the rice meal is based partly upon the open area of the die lip. For example, closing the lip or reducing the open area of the lip can increase the shear imparted to the rice meal. Conversely, opening the lip and increasing the open area of the lip can decrease the shear. Thus, the die lip can be used as a lever to control the level of shear imparted to the rice meal. If the die lip is opened to decrease the shear, the ribbon thickness exiting the extruder will increase. However, stretching the ribbon can advantageously reduce this thickness as desired thereby permitting the die lip to be adjusted to control the shear without negatively impacting throughput. Second, such stretching 130 permits the extrusion of ribbons which are thinner because there is less worry about overcooking the rice meal from a reduced open area. Third, the ribbon thickness affects the appearance and curling in the final product. Ribbon stretching 130 can reduce the tendency of the ribbon to wrinkle. In one embodiment, the ribbon comprises an extruded thickness of about 1.5 mm and is stretched to a thickness of about 0.7 mm to about 1.2 mm.

In one embodiment, the ribbon is perforated after the extruder. However, perforating may be more desirable in baked, as opposed to fried pellets because perforated pellets can have a higher oil uptake than an unperforated pellet, resulting in a higher fat content snack.

The ribbon is then routed into a five pass belted cooler by a transfer conveyor belt for ribbon conditioning 140. In one embodiment, the ribbon conditioner comprises a multi-pass open wire-mesh conveyor to cool the ribbon and permits subsequent cutting. The conditioner is kept at about 27° C. to about 35° C., preferably 30° C., wherein cold air is applied to both sides (top and bottom) of the ribbon. Further, the air temperature in the tunnel is manipulated to achieve a ribbon temperature of about 27° C. to about 35° C. at the embosser and/or the cutter. The cooling of the ribbon also helps prevent the ribbon from wrapping on the embosser rollers or cutter.

In the ribbon embossing embodiment, after the ribbon exits the cooling tunnel in the ribbon conditioner, conveying rollers deliver the ribbons to separate embosser and anvil roller pairs. Alignment of the ribbons into the embosser/cutter unit operation is accomplished by manually adjusting the panning conveyors. The embosser rollers additionally serve to hold the ribbon to prevent it from swaying. Each sheet of ribbon is then lightly embossed.

Following embossing, or the ribbon conditioner if no embossing occurs, the ribbon or extrudate is cut 150 into pellets. In one embodiment, the cutter comprises a rotary die. The pellets can be cut 150 into a variety of shapes including, but not limited to, circles, triangles, squares, and hexagons.

In the cutting step 150, the entire width of the extruded ribbon may not be cut into pellets. The portion of the ribbon that is not formed into pellets is referred to as edge lace. The trimmed edge lace is chopped and then ground into pieces referred to as “regrind” 155. In one embodiment, the regrind 155 is recycled back into the process at the inlet of the preconditioner 110 at a rate of about 3% to about 10% by weight of the total meal feed rate. After cutting 150, the pellets are conveyed to a drying step 160.

The pellets are pneumatically transferred from the cutter discharge to a belted shaker dryer. The moisture level of the pellets entering this dryer is at about 29% to about 31% and is reduced to about 18% upon exiting. The shaker dryer temperature set point is about 75° C. and a relative humidity of between about 25% to about 30% for a dwell time of about 6 to 8 minutes. The shaker dryer dries the surface of the pellets thereby preventing compaction and deformation when the pellets are treated in the finishing dryer.

From the shaker dryer, the pellets are pneumatically transferred first to a 9-pass short dryer and then to a finishing dryer. Prior to the short dryer, the pellets are spread onto the belt with an oscillating spreader. The belted short dryer is set at about 46° C. and about 20 to about 30% RH (relative humidity). The short dryer reduces the moisture content of the pellets from about 18% down to a moisture content of about 14%. The pellets are pneumatically transferred from the short dryer to a five pass belted finishing dryer. The finishing dryer equilibrates the moisture gradients within the pellets and consists of three stages. Stage one is set at about 48° C. with about 35% RH. Stage two is set at about 47° C. with about 35% RH. Stage three is set at about 30° C. with about 70% RH. The final dryer reduces the moisture content of the pellets from about 14% down to a moisture content of about 12%. The residence time in each stage is between about 30 and about 40 minutes. Optionally, an ambient cooler conveyor is provided at the end of stage three to cool the pellets to room temperature after exiting the dryer. Thereafter, the pellets are immediately processed or are continuously fed into boxes or sacks for half-product or pellet packaging 170. If packed, these pellets can then be shipped to another location for further processing to form a snack product.

The pellets are then baked 188 at 425° F. to a moisture content of less than about 2% by weight. The pellets can then be seasoned 190 to taste in a seasoning drum. In one embodiment, baked pellets made from this process comprise an oil or fat content of less than about 18% by weight, with most of the fat originating from the oil spray in the seasoning drum. Such snack food corresponds to a snack food having less than about 5 grams of fat per a 28 gram serving. The single sheet rice pellet when baked has texture very similar to the traditional Japanese rice cracker product made with the traditional, slow cooking, multi-day process. The present invention thereby permits a rice cracker to be made in a fraction of the time required by prior art rice crackers.

### EXAMPLE 2

### Baked Low-Fat Whole Grain Rice Pellet with Vegetable Inclusions

Rice-based pellets are prepared in the same way as discussed in EXAMPLE 1, except that the white rice is replaced with whole grain brown rice. Whole grain brown rice flour, available from Sage V of Los Angeles, Calif. can be used. In addition, vegetable powder can be added in the range from 0-30%.

The pellets are air popped 186 at 400° F. in a hot air popper to a moisture content of less than about 2.5% by weight and a bulk density of 73 g/l. A Model 80 Puffer, available from Cretors, of Chicago, Ill. can be used. The pellets can then be seasoned 190 to taste in a seasoning drum. In one embodiment, air popped pellets made from this process comprise an oil or fat content of less than about 18% by weight, with most of the fat originating from the oil spray in the seasoning drum. Such snack food corresponds to a snack food having less than about 5 grams of fat per a 28 gram serving. Further, the flavor profile provided by the vegetable powders provides desirable taste.

### EXAMPLE 3

### A Low-Fat Veggie Snack Having a One-Third Vegetable Serving

In one embodiment, an expandable rice-based pellet is made from a rice flour admix having at least about 30% by weight medium grain rice, at least about 20% pre-cooked rice flour, less than about 20% pre-gelatinized potato starch, and the remainder of the admix comprising a vegetable powder. More specifically, and again referring to FIG. 1, the rice flour ingredients 101 are first weighed, which include two different rice flours. Medium grain rice at about 40% and pre-cooked rice flour at about 30% by weight are admixed with secondary ingredients 102 comprising 15% pregelatinized potato starch and about 10% tomato powder, and minor ingredients 103 comprising less than about 1% of an emulsifier and oil at about 1% to about 3%, and more preferably about 1.5%, and salt at about 1.5%.

In one embodiment, the medium grain rice flour to pre-cooked rice flour comprises a ratio of between about 1.50:1.00 to 1.25:1.00. Such ratio can result in a superior texture and appearance of the vegetable-based rice pellet. Although pre-gelatinized potato starch is specified, any suitable starch can be used to improve machineability of the rice flours through the extruder that sufficiently maintains the elasticity of the extrudate (e.g. ribbon or dough balls) exiting the extruder die. Such starch can also have a positive impact on the final product texture.

The rice flour mixture is then mixed 100 to assure sufficient blending of the ingredients, which for example can occur after about 15 minutes to make a rice flour admix. The rice flour admix is volumetrically fed to a preconditioner 110 which is a single shafted paddle mixer for example. In the preconditioner 110, moisture is added to the dry mixture in the form of liquid water and steam to hydrate and partially gelatinize the mixture. In this embodiment, the rice flour admix enters the preconditioner 110 at a wet basis moisture of about 9% to about 12% and exits as the twin screw extruder as a meal at about 28% to about 31%. In a preferred embodiment, the meal's mean residence time in the preconditioner 110 is about 1 to about 3 minutes. The total combined weight of the hydrating components 112 comprising water or steam is maintained in order to achieve a consistent moisture level of the meal as it exits the preconditioner. The water that is added is preheated typically to about 65° C. to about 71° C. to maintain an exit temperature of the mixture at about 60° C. to about 90° C., more preferably about 77° C. which is adequate to inhibit microbial growth within the preconditioner 110 and sufficiently encourages the diffusion of steam and water into the meal. The amount of steam can be adjusted to control the exit temperature of the meal from the preconditioner 110. A hot water jacket around the preconditioner 110 can additionally be used to moderate and control the temperature level of the mixture. Oil 114, such as partially hydrogenated cotton and/or soy oil, is added to the preconditioner 110 to aid with handling of the product after extrusion.

After preconditioning 110, the meal is fed to a twin screw extruder as described in Example 1 for an extruding step 120. The extruder can be set to a screw RPM of 300 RPM and preferably between 250 RPM to 320 RPM to optimize the mechanical input to the meal. Barrel zones two through five are heated to a barrel temperature sufficient to achieve the desired level of cook by mechanical and thermal processes, which is generally about 80° C. Barrel zones six through nine are cooled to about 70° C. to minimize extrudate die temperature and to help reduce steam flashing at the die. Otherwise, too much steam flashing produces undesirable bubbles in the resulting extrudate ribbon as the temperature of the extrudate reaches about 101° C. to about 102° C. and is exposed to atmospheric pressure. The extruder has a lateral and central head temperature of about 80° C. and a die pressure of about 22 to about 30 bar. Further, a vacuum vent is attached to zone six to remove excess steam and provide evaporative cooling of the extrudate. A typical vacuum level is achieved at about 50 mm of mercury with an evaporative rate of about 15 kilograms to 30 kilograms of water per hour.

Another quality control feature of the invention is the variation of water added to the extruder. Since the flour mixture has been hydrated in the preconditioner 110 and excess water can be removed by vacuum, the addition of water acts as a lubricant to the flour mixture, reducing its viscosity and, thereby, reducing the residence time of the flour mixture in the extruder. This reduces the torque required to transfer the less viscous product through the extruder. Consequently, the addition of water to the extruder reduces the cook level.

The extruder is run at a higher RPM in this example to increase mechanical work on the dough. In the previous examples, the die pressure is high so the dough gets additional cooking in the die. In this example, the die pressure is kept lower. Consequently, a higher RPM is used in the extruder to provide the required work input to the dough. Sufficient work should be imparted to the dough in the extruder, because the former/cutter 125 imparts relatively little work on the dough. If sufficient work is not imparted to the dough in the extruder, there may be a negative impact on finished product texture. The dough exiting the extruder, however, is still considered a low sheared dough.

Following the extrusion step 120, the minimally sheared extrudate then exits the twin-screw extruder as small dough balls having a moisture content of at least 25% by weight and between about 10 mm and about 20 mm in size. These dough balls are fed to a low shear single screw former for a forming/cutting step 125. The barrel temperature is maintained between about 60° C. and about 80° C. and more preferably about 70° C. The former can comprise a die plate with the same or multiple shapes and a rotary cutter to cut the pellet at the die face. A single screw former available from Pavan (http://www.pavan.com) can be used. The cut pellets are then transferred from the cutter discharge to the drying step 160 for drying as disclosed in Example 1.

In one embodiment, the pellets are then baked 188 at 450° F. to a moisture content of less than about 2% by weight. The pellets can then be seasoned 190 to taste in a seasoning drum. In one embodiment, baked pellets made from this process comprise an oil or fat content of less than about 18% by weight, with most of the fat originating from the oil spray in the seasoning drum. Such snack food corresponds to a snack food having less than about 5 grams of fat per a 28 gram serving. Further, the flavor profile provided by the tomato powder provides desirable taste and a one-third of a vegetable serving in a 28-gram serving size of snack food.

### EXAMPLE 4

### Fried Reduced Fat Whole Grain Rice Pellet with Vegetable Inclusions

The pellets are prepared in the same way as discussed in EXAMPLE 1, except that the white rice is replaced with whole grain brown rice. Whole grain rice flour, available from Sage V of Los Angeles, Calif. can be used.

In one embodiment, the rice-based pellets were tempered at 82° C. (180° F.) for about 6 minutes from a moisture content of about 12% to a moisture content of about 11%. The pellets were then fried in hot oil at 191° C. (375° F.) for 32 seconds to a moisture content of about 2.5% by weight. The resultant pellets comprised an oil content of about 11% and further comprised a bulk density of about 80 g/l. The fried base is oil sprayed and seasoned in a rotating drum typical of corn chip processing. The pellets comprised a final total oil content including oil from the fryer and oil from the oil spray in the seasoning drum of less than about 18% by weight. In one embodiment, the fried pellet comprises an oil content of between about 10% and about 18% by weight. Such snack food corresponds to a snack food having less than 6 grams of fat per a 28 gram serving. By comparison, if the pellets are not tempered or pre-heated prior to the frying step, the fried pellets can comprise a finished base oil content of between about 27% to about 33% by weight. The resultant expanded rice-based snack product had mouthfeel and mouthbite comparable to a fried corn or potato expanded snack.

While the invention has been particularly shown and described with reference to a preferred embodiment, it will be understood by those skilled in the art that various changes in form and detail may be made therein without departing from the spirit and scope of the invention.

What is claimed is:

1. A method for making an expandable rice-based pellet comprising the steps of:
a) hydrating a rice flour admix in a pre-conditioner to make a rice meal;
b) extruding said rice meal through an extruder into an extrudate at a low shear rate;
c) cutting said extrudate into pellets; and
d) drying said pellets to a moisture content of between about 9% and about 13%.

2. The method of claim 1 wherein said rice flour admix comprises one or more rice flour types selected from short grain rice flour, long grain rice flour, and medium grain rice flour.

3. The method of claim 1 wherein said rice flour admix comprises one or more rice flour varieties selected from white rice, medium grain rice, brown rice, basmati rice, Wehani rice, jasmine rice, Arborio rice, wild rice, and converted rice.

4. The method of claim 1 wherein said rice flour admix comprises rice flour that is selected from gelatinized rice flour, partially gelatinized rice flour, partially pre-cooked rice flour, pre-cooked rice flour, par-boiled rice flour, uncooked rice flour, and extruded rice flour.

5. The method of claim 1 wherein said rice flour admix comprises whole grain rice flour.

6. The method of claim 1 wherein said rice flour admix further comprises:
at least about 30% by weight medium grain rice;
at least about 20% pre-cooked rice flour;
less than about 20% pre-gelatinized potato starch; and
at least about 1% vegetable powder.

7. The method of claim 6, wherein said medium grain rice flour to said pre-cooked rice flour comprises a ratio of between about 1.50:1.00 to 1.25:1.00.

8. The method of claim 6, wherein said vegetable powder further comprises at least about 10% tomato powder.

9. The method of claim 1, wherein rice flour admix further comprises one or more vegetable powders selected from tomato powder, spinach powder, and asparagus powder.

10. The method of claim 1, wherein rice flour admix further comprises one or more vegetable powders selected from carrot, broccoli, cucumber, kale, leek, parsley, bean, beetroot, horseradish, zucchini, cabbage, celery, cauliflower, green bell pepper, Brussels sprouts, onion, pea, garlic, and ginger.

11. The method of claim 1, wherein said vegetable powder further comprises a sufficient amount of vegetable such that said expandable rice-based pellet comprises at least one-third vegetable serving.

12. The method of claim 1, wherein said extruder imparts a specific mechanical energy of between about 80 to about 140 watt-hours per kilogram of extrudate.

13. The method of claim 1, wherein said extrudate at step b) creates dough balls having a diameter of between about 10 to about 20 millimeters.

14. The method of claim 1 wherein said pieces are fed to a low shear single screw former prior to step d).

15. The method of claim 14 wherein said barrel temperature of said former is below about 70° C.

16. The method of claim 14 wherein said pieces comprise a moisture content of greater than about 20% by weight after step c) and before step d).

17. The method of claim 14 wherein said pellets are baked after step d) to make an expanded snack having a fat content of less than about 18% by weight.

18. The method of claim 1 wherein said extrudate after step b) comprises a ribbon wherein said ribbon comprises a thickness of between about 0.7 mm and about 1.2 mm.

19. The method of claim 18 wherein the thickness is controlled by controlling a die lip on said extruder.

20. The method of claim 18 wherein said thickness is controlled by stretching said ribbon.

21. A method for making a reduced-fat fried rice snack food from a pellet, said method comprising the steps of:
a) providing a rice-based pellet;
b) pre-heating said rice-based pellet to sufficiently melt at least a portion of the outer pellet surface; and
c) frying said rice-based pellet.

22. An expanded snack comprising:
a rice-based flour;
vegetable powder;
minor ingredients;
wherein said pellet is produced by mixing said rice flour, minor ingredients, and vegetable powder into a rice flour admix,
hydrating said admix in a pre-conditioner to make a rice meal;
extruding said rice meal at a low shear rate into an extrudate;
drying said extrudate to a moisture content of between 9% and about 13% to make an expandable pellet; and
expanding said pellet into an expanded snack in a cooking step.

23. The expanded snack of claim 22 wherein said cooking step comprises pre-heating step followed by a frying step to a make a reduced fat expanded snack.

24. The expanded snack of claim 22 wherein said cooking step comprises baking to a make a reduced fat expanded snack.

25. The expanded snack of claim 22 wherein said cooking step comprises air popping to a make a reduced fat expanded snack.

26. The expanded snack of claim 22 wherein said expanded snack comprises at least one-third vegetable serving.
